(19) United States
(12) Patent Application Publication
(10) Pub. No.: US 2022/0111233 A1
(43) Pub. Date: Apr. 14, 2022

(54) Mask with Composite Air Duct

(71) Applicant: Invent-it BV, Sint-Niklaas (BE)

(72) Inventor: Ivan Peeters, Beveren-Waas (BE)

(21) Appl. No.: 17/169,381

(22) Filed: Feb. 5, 2021

(30) Foreign Application Priority Data
Oct. 14, 2020 (BE) BE2020/0109

(51) Int. Cl. A62B 18/02; A41D 13/11; A62B 18/08; A62B 7/10; A62B 23/02; B01D 46/00

(52) U.S. Cl. CPC A62B 18/025; A41D 13/1115; A41D 13/1192; A62B 18/084; B01D 2279/40; A62B 23/02; B01D 46/0036; B01D 46/0028; A62B 7/10

(57) ABSTRACT

The present invention relates to face mask with a formed air duct, which makes it much easier for the user of the face mask to breathe. The facial layer of the face mask is provided with an extra piece. This support layer is located at the level of the chin of the skin and contacts the face layer in such a way that an air duct is created between the face layer and the support layer. Also, a filter can be fitted in this air duct.

### CROSS REFERENCE TO RELATED APPLICATIONS

The present application claims priority to Belgian patent application No. BE2020/0109, filed on Oct. 14, 2020 which is incorporated herein by the reference.

### FIELD OF THE INVENTION

The present invention relates generally to face masks.

### BACKGROUND OF THE INVENTION

Various face masks are known in the art, such as the disposable face masks, which have a face part intended for covering the mouth and nose of the user and fastening means for attaching the face part to the face of the user. There are also reusable face masks with a face part in the form of a cover made of layers of fabric between which a replaceable filter is arranged. Face masks are also known in the art to have a preformed shell-shaped face part and provided with a filter.

In the known face masks, the fastening means are in the form of two stretchers on the sides of the face mask attached behind the user's ears, or the fastening means are in the form of ribbons tied behind the user's head. With the known face masks, disposable or not, preformed or not, the face part functions as an air filter for filtering the air to be breathed, and this part prevents drops from spreading when the user sneezes and/or coughs and also stops drops of other individuals from being inhaled by the user. In the known face masks, the intent is to push the air through the face part by pulling and pushing the facial area as much as possible as the user inhales and exhales, respectively.

The disadvantage of this approach is that it slows down the airflow considerably and makes breathing difficult. Another disadvantage is that the air also will try to escape from all sides, even upwards, and in certain circumstances will cause condensation (often referred to as “fog”) to form on a user's glasses.

### BRIEF SUMMARY OF THE INVENTION

The various embodiments of the present invention described herein may provide some or all of the above benefits for users. To this end, an object of the invention is to make a face mask with an air duct with a minimally impeded airflow without undermining the function of the face mask.

To achieve this, the face layer of the face mask, being the part where the filter is located in (for example) a medical face mask, is supplemented with a supporting role. This support part is situated at the height of the user's chin. The face mask with assembled air duct is, therefore, composed of a face layer, wherein the support portion of the face layer in such a manner draws together, which creates an air duct. Additionally, a filter can be placed in the air duct.

An advantage of this technique is that users may likely experience much more comfort when wearing it. Another advantage is that it may prevent the user from getting a headache from using a face mask. It's known that some users of face mask getting a headache after wearing a face mask after a certain period due to lack of oxygen or other causes.

An object of the present invention is, by creating a semi-permanent air duct within the face mask itself, the wearer enjoys the assurance that the exhaled air can be expelled through a predetermined outlet. By then specifically shaping and directing the air duct, this discharge direction can be directed downwards, along the chin, to avoid fogged glasses and the like, but also to ensure that the exhaled air does not flow to other people, or at least to a lesser extent. Moreover, fresh air can also be sucked back in very easily.

An additional functionality may be flow control. Controlling the air duct cross-section ensures that exhaled air is expelled at a high velocity so that fresh air can be drawn in, whereas, with many face masks, a substantial portion of the ‘fresh’ air is the old, exhaled air.

### BRIEF DESCRIPTION OF THE DRAWINGS

The drawings are provided for purposes of illustration only, and merely depict typical or example embodiments of the invention. These drawings are provided to facilitate the reader's understanding of the invention and shall not be considered as limiting of the breadth, scope, or applicability of the invention.

FIG. 1 outlines a current problem with common face masks.

FIG. 2 demonstrates the operation of a possible embodiment of the present invention.

FIG. 3 is a rear view of a disposable face mask provided with an additional backing that allows an air duct to be formed.

FIG. 4 is a rear view of a disposable face mask provided with an additional support layer that makes it possible to supplemented to form an air duct with self-adhesive strips that allow for to adhere the face mask to the face.

FIG. 5 is a rear view of a disposable face mask provided with an additional support layer that makes it possible to form an air duct, the face layer being in a trapezoidal shape.

FIG. 6 is a side view of a face mask provided with an extra support layer that makes it possible to form an air duct.

FIG. 7 is a rear view of a disposable face mask that may be provided with an add on the support layer, which makes it possible to form an air duct.

FIG. 8 is a top view of a disposable face mask that can be provided with an add-on backing that allows the formation of an air duct.

### DETAILED DESCRIPTION

Several aspects of embodiments of the invention are described below with reference to example applications in the attached figures for illustration. It should be understood that numerous specific details, relationships, and methods are set forth to provide an understanding of the invention. One skilled in the relevant art, however, will readily recognize that the invention can be practiced without one or more of the specific details or with other methods.

In other instances, well-known structures or operations are not shown in detail to avoid obscuring various aspects of different embodiments of the invention. The present invention is not limited by the illustrated ordering of acts or events (unless a certain order is explicitly necessary), as some acts may occur in different orders and/or concurrently with other acts or events. Furthermore, not all illustrated acts or events are required to implement a methodology in accordance with the present invention.

In a first aspect, the invention relates to a face mask having a face part made of at least a support and a face layer for covering the mouth and nose of a user when in use, with attachment means for attaching the face mask to the face of the user, characterized in that the support and face layer are interconnected at least two separate attachment zones, between which attachment zones the support and face layer are not connected. The length of the support layer between the two separate attachment zones and the length of the face layer between the two separate attachment zones are different, creating an air duct between the support and face layer in use. The air duct's opening is preferably located on the face mask's underside, and preferably the support layer is not in front of the user's mouth.

In a second aspect, the embodiment relates to a face mask having a face part made up of at least a support and a face layer for covering the mouth and nose of a user when in use. Attachment means attach the face mask to the face of the user. The support layer comprises a chin layer and a contact layer which are connected to at least two separate attachment zones, between which attachment zones the chin and contact layer are not joined. The length of the chin layer between the two separate attachment zones and the length of the contact layer between the two separate attachment zones are different, creating an air duct between the chin and contact layers when in use. Preferably the length of the contact layer between the two separate attachment zones is greater than the length of the chin layer between the two separate attachment zones. Also, the support layer via the contact layer can be attached to the face layer, preferably wherein the contact layer is provided with at least one, optionally deformable, structure-supporting element, preferably a metal, cardboard or plastic wire or strip, for spatial separation of the face layer and the support layer between the two attachment zones.

In a third aspect, the invention relates to an air-channel that can be added as an add-on to an existing face mask. This air duct comprises a chin layer and a contact layer which are connected to at least two separate attachment zones, between which attachment zones the chin and contact layer are not connected, the length of the chin layer being between the two separate attachment zones and the length of the contact layer between the two separate attachment zones are different from creating an air duct between the chin and contact layers in use, preferably wherein the length of the contact layer between the two separate attachment zones is greater than the length of the chin layer between the two separate attachment zones. The air duct can be connected via the contact layer to a face mask on the inside, preferably wherein the contact layer (and/or the chin layer) is provided with at least one, optionally deformable, structure-supporting element, preferably a metal, cardboard, or plastic wire or strip, for spatial separation of the face mask and the backing between the two attachment zones.

It is to be understood that all of the following embodiments can be easily applied to any of the above three aspects.

In a preferred embodiment, a face mask is described as a standard shape with an additional strip applied. This strip is placed on the inside of the mask and is narrower than the outside of the mask itself. In an embodiment in which adhesive strips are used, adhesive strips are applied to the attachment zone of this additional strip, being the support layer. With these adhesive strips, the support layer can be glued to the outer layer, being the facial layer, creating an air duct. However, it is also possible for the adhesive strips to be applied at corners on the face layer's underside instead of at the corners of the support layer. However, a combination of the two previous techniques is also possible. The fact that the distance between the attachment zones at the support layer is smaller than the distance between the face layer's attachment zones causes the face layer between the attachment zone to bulge, and an air duct is thus formed. For persons with a smaller face, for versions where the mask is larger than the standard dimensions or other possible situations where this is required, the attachment zones can be placed more towards the center.

In the embodiment described above, the support layer can be applied to the face layer without adhesive strips. Conversely, it is also possible for the attachment zones to be provided with adhesive strips on the support layer's side, thus protecting the face layer from adhesive strips if the support layer is not yet attached. An additional variant is that adhesive strips are applied to both the face layer and the support layer, making the adhesion between the two layers stronger.

These adhesive strips are preferably double-sided adhesives, wherein, in production, the adhesive strips on the respective layers are applied using a bonding adhesive, and wherein the other side is provided with a plastic film. This foil can be removed by the user at the time that the user wants to connect the support layer with the facial layer.

To connect the facial layer and support layer with disposable face masks, it is recommended to use at least one adhesive strip. A possible variant is that one attachment side between the face layer and support layer is fused by, for example, pressing the two layers on the attachment zone together under high pressure at a high temperature. The other attachment zone can then be bonded together using an adhesive bond.

With face masks that are of the reusable type, such as fabric masks, it may be more appropriate that the support layer is already attached to the face layer during production. With a fabric mask, these pieces can be stitched together, by machine or by hand. But attachment techniques of a non-permanent nature are also possible. For example, pushbuttons can be used to attach the face layer to the support layer at the mounting locations. Other attaching techniques are also possible, such as a click or sliding system where the support layer can be attached to the face layer with a simple movement.

An additional advantage of this embodiment is that, in the case of medical masks, existing masks can be used, whereby the supporting layer is applied as an extra during the production process.

In another preferred embodiment, a face mask has a trapezoidal shape in which the support portion has adhered to at the bottom of the face layer. The attachment methods may be similar to the previous preferred embodiment. However, in this embodiment, it is appropriate but not necessary that the fasteners of the lower fasteners, such as the stretchers, be directly connected to the support layer, and the upper fastener fasteners attached to the top of the face layer. The advantage of this is that in use, the mask acquires a rectangular shape that can be parallel to a model that does not use a support layer.

In another preferred embodiment, a face mask has a trapezoidal shape in which the face layer at the bottom is assembled adjusted with the support portion at manufacture. In fabric embodiments, it is recommended that the support layer is already attached to the face layer during production. This can be done, for example, by sewing the two layers together at the ends of the bottoms. With these types of embodiments, it is also possible that the support layer and face layer are manufactured in one piece. This can be done by developing a suitable weaving technique, but also by 3D printing or other similar techniques.

An additional advantage of this is that the user does not have to do anything himself to form the air duct. The air duct is automatically created when putting on the face mask. This mask can also be washed and makes it suitable for reuse.

In another preferred embodiment, some type of add-on is provided on a face mask, which could be a standard conventional face mask. Here, the mask with a face part is constructed from at least a support and a face layer to cover the mouth and nose of a user during use, and with fastening means for fastening the face mask to the face of the user. The fastening means for connecting the contact layer and chin layer can be the same as already described above in the previous preferred embodiments. This is also for the connection between the contact layer and face layer, with the difference that there is already with the first fastening work can be carried zone, which preferably covers the entire surface area of one side of the contact layer.

The support layer comprises a chin layer and a contact layer which are connected to at least two separate attachment zones, between which attachment zones the chin layer and contact layer are not connected to each other, wherein the length of the chine layer between the two separate attachment zones and the length of the contact layer between the two individual attachment zones are different.

Because of this, during use, an air duct arises between the chin and contact layer, preferably wherein the length of the contact layer between the two separate attachment zones is greater than the length of the china layer between the two separate attachment zones. An additional advantage of this version is that this add-on can be supplied as a completely separate item with existing face masks where the dimensions, shape, and composition of the existing layers are less important or, in certain versions, not at all important.

In a possible embodiment, a mask made of fabric can be built upon three layers for the face layer, wherein the inside and outside are provided with a fabric comprised of cotton, for example, between which there is provided an extra layer filtered. The supporting layer can consist of only one layer that is sufficiently strong to absorb the forces. Options that can be supplemented to the preferred embodiments and by extension to other variants without being limiting.

Molding brace: preferably, at least one brace is placed at the height of the mouth opening. With most face masks, this means that it is positioned in the middle of the face mask or therefore in the middle of the facial layer. The set-up is horizontal, but in certain versions, a vertical set-up is also possible.

If the material, shape, or application requires this, several molding braces can be incorporated in the face layer, possibly combined with molding braces in the support layer. This molding brace may consist of a deformable but relatively solid material, which is preferably placed in the relevant layer. Both the face layer and the support layer are preferably made up of several layers. The molding brace itself can consist of the same construction as the nose clips used in the current disposable face masks.

Blocking strip: with non-medical masks, especially fabric masks, the air that passes through the facial layer is minimally filtered. In some cases, the required filtering capacity needs to be greater, or one wants to avoid pushing the air particles with water droplets too far forward when exhaling. In the present invention, this can be compensated for by providing the surface of the facial slab at the level of the oral cavity with a layer that will additionally slow down or even completely block the air. Since the airflow created by inhaling and exhaling is limited in a straight line in front of the oral cavity, the airflow will look for another way. Since an air duct is provided in which the airflow's deceleration is limited to a minimum, the airflow will divert its way and mostly flow through the formed air duct. In most cases, the air duct is formed in such a way that the outgoing airflow is propelled in the direction of the user himself so that the persons around the user are additionally protected.

Filter: can be set up both transversely and along the air duct. Since the air duct formed is much longer than the filter's thickness in the face layer, types of filters can be fitted, allowing the air to pass through much more easily but still have the same filtering effect. A possible embodiment of this is applying filter strips at a specific distance, e.g., 0.5 mm in the longitudinal direction of the air duct. The water droplets in the airstrip containing the viruses get stuck or at least slowed down in these strips. A possible variant of this is the air duct provided with several filter layers that minimize the airstrip. By placing several of these filter layers one after the other, a high filter content can still be obtained without slowing down the airflow too much. This type of filter preferably closes off the entire air duct.

The air duct can also be provided with fastening means such as an adhesive or velcro to hold the filter in place in the air duct during use. The fasteners may be provided within this air duct on the face layer side of the support layer or both sides.

The filter can be provided with active ingredients such as activated carbon, known to have a cleaning and filtering function.

Self-adhesive strips: In addition to the duct forming techniques, it may be useful in certain cases to prevent the airflow from flowing through the other sides, such as the bottom or top. Fogging is often a significant problem for people who wear glasses. To solve this problem, the mask can be provided with adhesive strips that connect the mask to the skin. Preferred are one or more strips of a double-sided self-adhesive design, one side is to meet the face mask to bond and the other to accommodate the user's face to adhere. Preferably, the adhesive layer of the strips formed from a pressure-sensitive adhesive, which in other words, an easy release is to make and moreover, allows to get on and off to do the same face mask several times without the adhesive force to the skin being substantially reduced.

The strips can be provided on the side intended to adhere to the face with a peelable cover foil that must be removed before using the face mask. An advantage of such a removable cover foil is that it will keep the adhesive layer of the strips clean and undamaged so that the adhesive layer adheres optimally after removing the cover foil.

Bactericidal substance: research shows that breeding grounds for bacteria occurs when users do not wash or change their face masks regularly. At worst, this can lead to infections of the skin or even the lungs. When a face mask is worn for too long without cleaning, it becomes a breeding ground for bacteria. When the user breathes, there are hot and humid particles containing food, which creates the ideal setting for bacteria to live.

Most bacteria and fungi on the face mask are harmless, but some face mask bacteria such as staphylococci are pathogenic. These and other types of bacteria can cause acute sinusitis and skin infections such as acne. In the nose, mouth, and skin, these usually are suppressed by the human immune system, but on a face mask, this is not the case, and they can grow to higher concentrations outside the body. Hence the guideline that a face mask may be worn for a maximum of 4 hours, and then it must be replaced. However, in practice hardly anyone does that.

If the facial layer includes a layer with hyperforin, which repels and kills bacteria so a culture buildup can be prevented in the face mask. However, this is not possible with conventional face masks as this bactericidal matter would greatly slow down the face layer's airflow. However, this is possible in many configurations of the present invention.

The items in the various figures are enumerated as follows:

Item 1. Face mask with air duct: this is the face mask made up of a face layer and support layer.

Item 2. Face layer: this is the layer on the outside of the face mask and in which the filtering part is located.

Item 3. Support layer: this is the layer that is situated at the height of the chin.

Item 4. Face part: with the already known face masks, this is the part that forms the base of the mask, and where medical masks, the filter is applied as an intermediate layer.

Item 5. Fasteners: these are how the face mask is attached. These can consist of a stretcher for behind the ears or strings to be tied together behind the head.

Item 6. Nose clip: in most versions, this consists of a metal strip incorporated into the face layer and can be folded into the nose's shape to allow as little air as possible to escape from above.

Item 7. Molding brace: in most versions, this will consist of a metal strip incorporated into the facial layer at the oral cavity height. This can be built up from several strips. Its purpose is to form the face layer to not pull towards the mouth when inhaled. The air duct also retains its maximum capacity in this way.

Item 8. Adhesive strip: this is an adhesive element that, in the versions where the support layer has to be manually attached to the face layer, ensures that the support layer can be applied to the face layer. This adhesive strip will, in some cases, be provided with a foil that is removable when the support layer has to be glued to a face layer, or vice versa, depending on the embodiment.

Item 9. Air Duct: This is the channel formed between the face layer and support layer. An extra filter can also be installed within this air duct.

Item 10. Filter: this is a filter that mainly has to stop the moisture particles in the air.

Item 11. Foil: this is the protective foil that is applied to the adhesive strips and/or self-adhesive strips

Item 12. Attachment points with fasteners: This is the connection between the fasteners and the face layer. Depending on the design, at least some of the fixing points can be connected to the support layer.

Item 13. Blocking Strip: the purpose of this strip is to at least partially block the airflow at the level of the oral cavity so that the air is directed to the air duct. This strip can be composed of a material such as paper, cardboard, but even of filter material as incorporated in the facial layer, but with a higher density, making it much more difficult for air to pass through. Depending on the material used, this strip can also be used as a molding brace.

Item 14. Adhesive strips: These are strips that come with an adhesive to adhere the mask to the skin, eliminating the need for fasteners. In commercial use, these are provided with a foil that must be removed before applying the mask to the skin.

Item 15. Known face mask: this is a version of the known face masks without an air duct.

Item 16. Face mask without duct: this is a face mask, possibly already known face mask, suitable for attaching an add-on support mask.

Item 17. Support layer device: composed of a contact layer and chin layer. This can then be applied as an add-on to an existing face mask. This can be done by adhesive, but also, for example, by a velcro connection.

Item 18. Contact Layer: This is the layer of the support layer device that is applied to the face layer.

Item 19. Chin Layer: This is the layer of the support layer device that is applied to the contact layer. One possibility here is that the end is attached on one side, and the chin layer is glued to the adhesive strip of the contact layer on the other side when the air duct is to be formed.

Item 20. A left adhesive strip like item 8 on backing

Item 21. A right adhesive strip like item 8 on backing

Item 22. A right adhesive strip like item 8 on the face layer

Item 23. A left adhesive strip like item 8 on the face layer

Item 24. Contact adhesive strip: this has the function of attaching the support layer to the face layer if the support layer is performed as an add-on. The adhesive strip can be one large strip or divided into smaller parts.

With the insight to better demonstrate the invention's features, some preferred embodiments of a face mask according to the invention are described below, by way of example without any limitation, concerning the accompanying drawings.

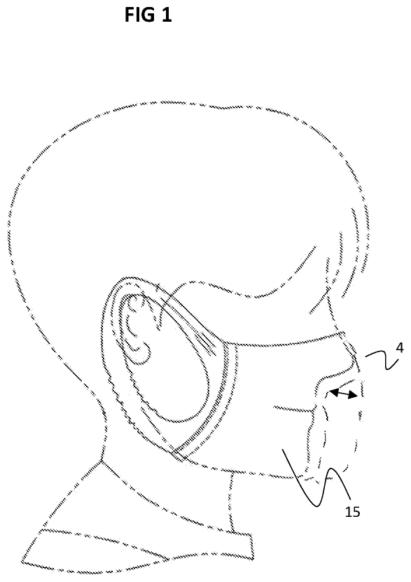

With known face masks 15, it is a known problem that when breathing in and out, the face part 4 moves along with the airflow as illustrated in FIG. 1. Particularly during inhalation, the face part 4 has the property of blocking the oral cavity entrance. This has the drawback that the user of this face mask 15 has to make a more significant effort when breathing, which many users consider to be very uncomfortable.

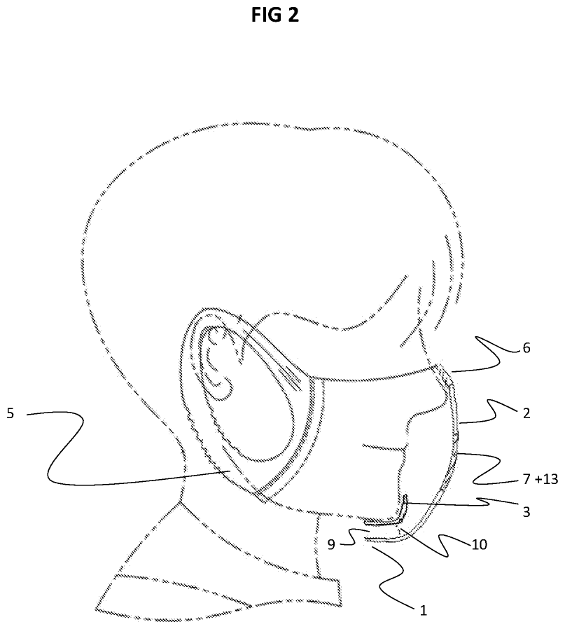

FIG. 2 shows a basic arrangement of the face mask with air duct 1 in which a face layer 2 is situated in the same place as the face part 4 in a known face mask 15. In this embodiment, an air duct 9 is formed at the height of the user's chin. Between the support layer 3, which makes contact with the user's chin, and the facial layer 2 is the air duct 9. A filter 10 can be arranged in this air duct 9. This filter 10 can be a single layer, as indicated in FIG. 2, but also multi-layer. Also, this filter 10 can be replaceable, which may be of interest in the case of the reusable embodiments. The face mask 1 is preferably also equipped with a nose clip 6 as it is already used in the current face masks 15. Furthermore, the facial layer 2 can also be supplemented by a blocking strip 13, which will at least partially slow down the airflow caused by the user's inhalation and exhalation. As a result, the airflow will look for another way, and the easiest way is the air duct 9. The blocking strip can also fulfill the role of molding brace 7. This molding brace 7 aims to keep the formed air duct 9 this shape and even give the user the possibility to form the air duct themselves by shaping this molding brace. The embodiment of the face mask in FIG. 2 has stretchers that can be fitted behind the user's ears as fastening means.

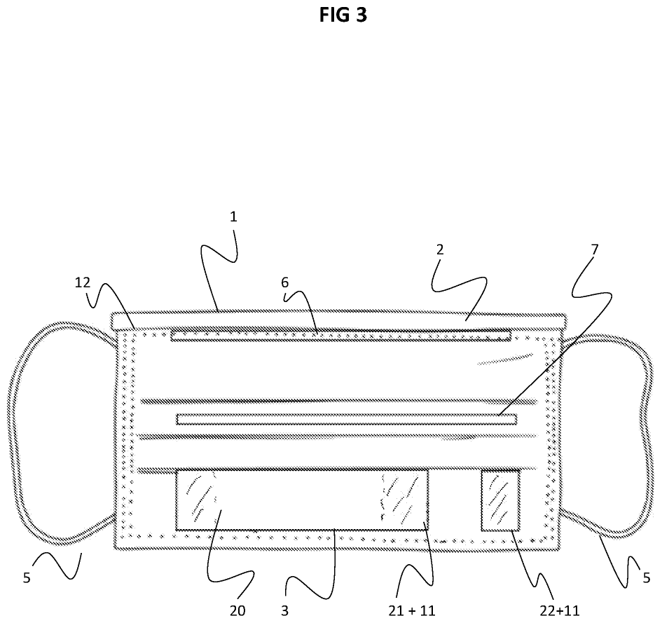

FIG. 3 shows an embodiment of a disposable face mask 1 in which the facial layer 2 is provided with a nose clip 6, a molding brace 7 which may have the same design as the nose clip 6 but instead of following the shape of the nose, the purpose of the molding brace 7 is to form the shape of the air duct 9. In FIG. 3 the molding brace is positioned in the middle of the facial layer 2, but it can also be placed further downwards so that it possibly comes to lie at the level of the top of the support layer 3. Possibly, the face layer 2 is provided with molding braces 7 in several places. The face mask 1 as shown in FIG. 3 has stretchers as fastening means attached to the face layer 2 of the face mask 1. At the bottom of the face layer 2 a support layer 3 is provided, which in this embodiment is equipped with two adhesive strips 8 which are positioned between the facial layer 2 and the support layer 3. The left side of the support layer 3 is connected via adhesive strip 20 already attached to the facial layer 2. The straight adhesive strip 21 on the support layer is provided with a release foil 11. On the face layer 2, an adhesive strip 22 will be provided with a foil 11 at the bottom right. When using the face mask 1, the user will remove the foil 11 on the adhesive strip 21 and the foil on the adhesive strip 22 provided on the face layer 2. Then the two adhesive strips 21 and 22 are glued together. Since the distance between the two adhesive strips 20 and 21 is smaller than the distance between adhesive strip 20 and adhesive strip 22, an air duct 9 will be formed between the face layer 2 and the support layer 3.

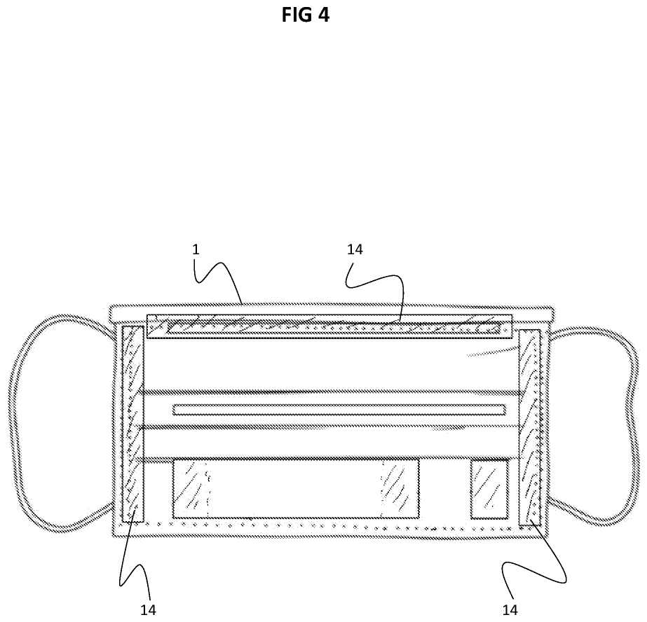

FIG. 4 shows the same embodiment as the embodiment in FIG. 3, but can be supplemented with self-adhesive strips 14 arranged on the top and sides of the facial layer 2 on the side of the user's face. These self-adhesive strips 14 are provided with a foil 11 that the user can remove before use. The user of the face mask 1 can then stick the face mask 1 to their face without the need to use the fastening means 5.

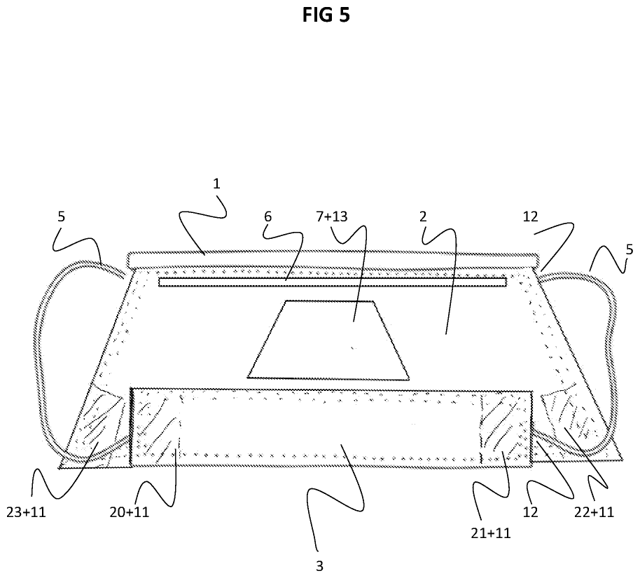

In FIG. 5, an embodiment is described in which the function and the method of use are the same as in FIG. 3, but here the intention is to have, when in use, the face layer 2 deform into the same rectangle shape as in the case where the supporting layer 3 is not used. To achieve this, facial layer 2 is made in the form of an isosceles trapezoid, the longest part of this trapezoid being situated at the bottom at the level of the support layer 3. Adhesive strips 8 are provided at the bottom corners of the facial layer on the side of the support layer 3. The ends of the support layer 3 are also provided with adhesive strips 8. In this embodiment, it is recommended, but not necessary, that the fasteners 5 at the top are connected to the face layer 3 and the fasteners 5 are connected at the bottom to the support layer 3. In use, the foils 11 of the different adhesive strips 10, 21, 22, and 23 and the left adhesive strip 20 of the support layer 3 can be applied to the left adhesive strip 23 of the face layer and the right adhesive strip 21 of the support layer 3 can be applied to the right adhesive strip 22 of the face layer. This creates an air duct 9 between the facial layer 2 and supporting layer 3. The facial layer 3 can also be provided with a blocking strip 13, which also serves as a molding brace 7 and a nose brace 6, possibly designed in the form of an isosceles trapezoid.

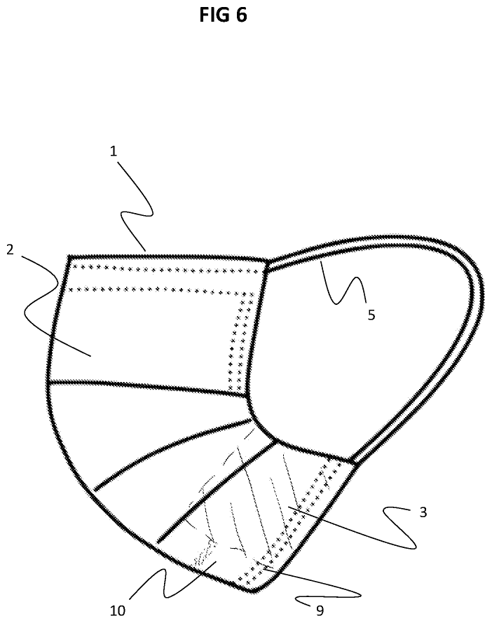

FIG. 6 shows a basic arrangement of the face mask 1 in use, in which the facial layer 2 forms the outside and the support layer 3 is arranged on the inside, whereby an air duct 9 is formed, provided with a filter 10.

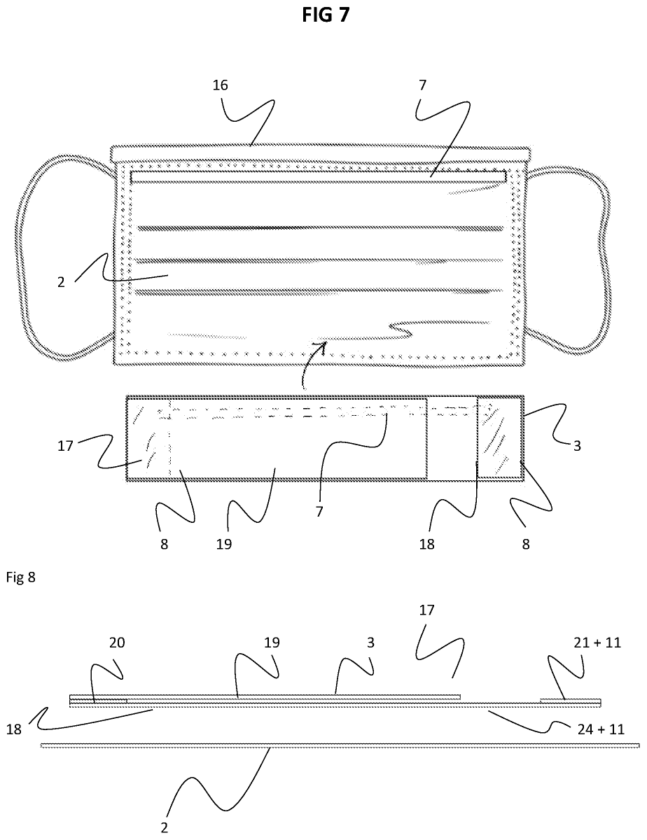

FIGS. 7 and 8 show an embodiment in which the support layer 3 is an add-on to an existing face mark. For example, support layer 3 can be attached to an existing face mask 16 so that this face mask 16 can still be converted into a face mask with air duct 1. This support layer 3 is composed of two separate layers, and the bottom layer is the contact layer 18, which is provided on the underside with an adhesive strip 24, preferably over the entire surface of the contact layer's underside 18, and a foil 11. A chin layer 19 is provided at the top of the support layer 3, the top of the chin layer 19 being in contact with the user's chin. An adhesive bond 20 is provided between the chin layer 19 and the contact layer 18. On the right side of the contact layer 18, an adhesive strip 21 with a cover foil 11 is also provided at the top.

In use, the user will remove the foil 11 at the bottom of the contact layer 18, and then the support layer 3 is applied to the bottom of the face layer 2. Afterward, the user can remove the foil 11 from the adhesive strip 21 on top of the contact layer 18 and stick the end on the right side of the chin layer 19 to this adhesive strip 21, thereby also creating an air duct 9 between the chin layer 19 and the contact layer 18. The contact layer 18 can also be provided with a molding brace 7 to support the air duct 9 in its shape.

While various embodiments of the present invention have been described above, it should be understood that they have been presented by way of example only, and not of limitation. Likewise, the various diagrams depict exemplary configurations for certain embodiments invention, which is done to aid in understanding the features and functionality that can be included in the invention. The invention is not restricted to the illustrated examples or configurations, but the desired features can be implemented using a variety of alternative architectures and configurations. Indeed, it will be apparent to one of skill in the art how alternative functional, logical, or physical partitioning and configurations can be implemented to implement (or discard) various features of the present invention.

Although the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above described exemplary embodiments.

What is claimed is:

1. A face mask comprising:
fasteners for attaching the mask to the face of a user;
a face layer for covering the mouth and nose of a user when in use; and
a support layer connected to the face layer, wherein the support layer and the face layer form an air duct when in use.

2. The mask of claim 1 wherein the support layer and the face layer are connected at two attachment zones.

3. The mask of claim 1 wherein the length of the support layer is less than the length of the face layer, said length measured between where the face and support layers are attached.

4. The mask of claim 1 wherein the fasteners comprise stretchers for attaching the face mask behind the ears of the user.

5. The mask of claim 1 wherein the fasteners comprise strings to tie behind the head of the user.

6. The mask of claim 1 wherein the fasteners comprise ribbons to tie behind the head of the user.

7. The mask of claim 1 wherein the air duct has a filter.

8. The mask of claim 1 wherein the air duct has at least one filter layer.

9. The mask of claim 1 wherein the air duct has a plurality of filter layers.

10. The mask of claim 1 wherein the air duct directs exhaled air downwards when in use by the user.

11. The mask of claim 1 wherein the air duct directs exhaled air towards the user when in use.

12. The mask of claim 1 wherein the air duct is located on the underside of the face mask.

13. The mask of claim 1 wherein the air duct is located at the user's chin when in use.

14. The mask of claim 1 wherein the mask is reusable.

15. The mask of claim 1 wherein the mask is washable.

16. The mask of claim 1 wherein air is expelled at a higher velocity through the air duct than the face layer.

17. The mask of claim 1 wherein the support layer and the face layer are not connected except at two attachment zones.

18. The mask of claim 1 wherein the face layer comprises a bactericide.

19. The mask of claim 1 wherein the face layer comprises cotton.

20. The mask of claim 1 wherein the face layer comprises a plurality of layers.

21. The mask of claim 1 wherein the support layer comprises a plurality of layers.

22. The mask of claim 1 wherein the support layer is not in front of the mouth opening of the user when in use.

23. The mask of claim 1 further comprising netting to support a filter.

24. The mask of claim 1 further comprising a filter with active carbon.
